(19) United States
(12) Patent Application Publication
(10) Pub. No.: US 2012/0188227 A1
(43) Pub. Date: Jul. 26, 2012

(54) METHOD FOR PAIRING SHUTTER GLASSES AND DISPLAY APPARATUS

(75) Inventors: Hsiao-Hua Yang, New Taipei City (TW); Chien-Lin Chen, New Taipei City (TW); Chien-Cheng Lin, New Taipei City (TW)

(73) Assignee: AmTRAN TECHNOLOGY CO., LTD, New Taipei City (TW)

(21) Appl. No.: 13/081,155

(22) Filed: Apr. 6, 2011

(30) Foreign Application Priority Data
Jan. 21, 2011 (TW) 100102335

(51) Int. Cl. G06T 15/00

(52) U.S. Cl. 345/419

(57) ABSTRACT

A method for pairing a pair of shutter glasses and a display apparatus includes providing a pair of shutter glasses, in which the pair of shutter glasses may switch turning on of the left shutter and the right shutter according to a default command; receiving an information packet sent from a display apparatus; parsing the information packet; and controlling on/off durations of the left shutter and the right shutter of the pair of shutter glasses according to a sequence of on/off commands in the information packet, in which the sequence of on/off commands in the information packet are different from the default command. The pair of shutter glasses is operable to review three-dimensional (3D) images presented by display apparatuses of different brands, thereby solving limitation of a fixed pairing of a pair of shutter glasses and a display apparatus of the same brand in the prior art.

### CROSS-REFERENCE TO RELATED APPLICATIONS

This non-provisional application claims priority under 35 U.S.C. §119(a) on Patent Application No. 100102335 filed in Taiwan, R.O.C. on Jan. 21, 2011, the entire contents of which are hereby incorporated by reference.

### BACKGROUND OF THE INVENTION

1. Field of the Invention

The present invention relates to a method for pairing a pair of shutter glasses and a display apparatus, and more particularly to a pairing method suitable for pairing shutter glasses and display apparatuses of different brands.

2. Related Art

Left and right eyes are located at different positions, so images observed by left and right eyes are different. Under circumstances that, differences exist between the left-eye image information observed by the left eye and the right-eye image information observed by the right eye, a human brain may be tricked to perceive a three-dimensional (3D) visual effect. Currently, in the 3D image display manner, the left-eye and right-eye images are arranged in horizontal or vertical positions such that the left eye can observe the left-eye image information merely and the right eye can observe the right-eye image information merely through a pair of polarized shutter glasses, thereby presenting a 3D image.

The 3D depth perception is mainly achieved by a specific system which comprises a display apparatus and a pair of shutter glasses. The display apparatus is capable of sending a specific sequence signal and sequentially displaying left-eye image information and right-eye image information, and the pair of shutter glasses is capable of receiving the specific sequence signal to make the user sequentially receive the left-eye image information and the right-eye image information merely. The specific sequence signal has a series of on/off control instructions. Therefore, when the display apparatus sends the specific sequence signal comprising the on/off control instructions to the corresponding pair of shutter glasses, the pair of shutter glasses may execute on/off actions of the left shutter and the right shutter according to the on/off control instructions.

Generally speaking, the on/off control instructions in the specific sequence signal must be consistent with display sequence of the left-eye image information and the right-eye image information. Therefore, when the left eye field of the pair of shutter glasses is actuated and the right eye field of the pair of shutter glasses is blocked, the observer may only review the left-eye image information, and when the right eye field of the pair of shutter glasses is actuated and the left eye field of the pair of shutter glasses is blocked, the observer may only review the right-eye image information. Since such switching actions are performed very quickly and consecutively, based on the human persistence of vision, the observer then perceives consecutive 3D images.

However, it is known to all that the specific system (comprising the display apparatus and the pair of shutter glasses) cannot present 3D images for the observer to review unless a certain pairing is performed. That is to say, the 3D image display apparatus and the pair of shutter glasses commercially available on the market must have the same communication and encoding protocols. For example, if the display apparatus and the pair of shutter glasses are not the same brand (that is, do not have the same encoding protocol), the pair of shutter glasses of an A brand cannot identify the codes sent from the display apparatus of a B brand. The situation not only limits user selection but also increases the inconvenience on using the display apparatus and the pair of shutter glasses.

### SUMMARY OF THE INVENTION

Accordingly, the present invention provides a method for pairing a pair of shutter glasses and a display apparatus, thereby solving the problems existing in the prior art.

The present invention provides a method for pairing a pair of shutter glasses and a display apparatus, which comprises the following steps. A pair of shutter glasses is provided, in which the pair of shutter glasses is suitable for switching turning on of a left shutter and a right shutter according to a default command. An information packet is received, in which the information packet is sent from a display apparatus and comprises a sequence of on/off commands. The information packet is parsed. On/off durations of the left shutter and the right shutter of the pair of shutter glasses are controlled according to the sequence of on/off commands to review a 3D image on the display apparatus, in which the sequence of on/off commands are different from the default command.

According to an embodiment of the present invention, the information packet is transferred from the display apparatus to the pair of shutter glasses in a wired or wireless manner.

When being transferred in the wireless manner, the information packet is transferred to the pair of shutter glasses through infrared rays, microwaves, or radio frequency electromagnetic waves. When being transferred in the wired manner, the information packet is transferred to the pair of shutter glasses via a universal serial bus interface.

The present invention also provides a method for pairing a pair of shutter glasses and a display apparatus, which comprises the following steps. A pair of shutter glasses is provided. A first information packet is received, in which the first information packet is sent from a first display apparatus and the first information packet comprises a sequence of on/off commands. The pair of shutter glasses forwards the first information packet to a second display apparatus. The second display apparatus parses the first information packet. A second information packet is received by the pair of shutter glasses, in which the second information packet is sent from the second display apparatus and the second information packet has the same sequence of on/off commands of the first information packet. On/off durations of the left shutter and the right shutter of the pair of shutter glasses are controlled according to the sequence of on/off commands to review 3D images on the first display apparatus and/or the second display apparatus.

According to an embodiment of the present invention, the pair of shutter glasses has a trigger unit, and when the trigger unit is triggered, the pair of shutter glasses receives the first information packet.

According to an embodiment of the present invention, the pair of shutter glasses has an emitting terminal, and when the trigger unit is triggered for over a threshold period, the emitting terminal of the pair of shutter glasses forwards the first information packet to the second display apparatus.

According to an embodiment of the present invention, the pair of shutter glasses has an indication unit, and when the pair of shutter glasses finishes forwarding the first information packet, the indication unit sends an indication signal.

The present invention further provides a method for pairing a pair of shutter glasses and a display apparatus, which comprises the following steps. A display apparatus is provided, in which the display apparatus is suitable for sending packet information comprising a default command. A first information packet is received, in which the first information packet is sent from a pair of shutter glasses and the first information packet comprises a sequence of on/off commands. The first information packet is parsed. When a 3D image is displayed, a second information packet is sent, in which the second information packet has the same sequence of on/off commands of the first information packet and the sequence of on/off commands are different from the default command.

According to an embodiment of the present invention, the first information packet is transferred from the pair of shutter glasses to the display apparatus via a universal serial bus interface.

According to an embodiment of the present invention, the pair of shutter glasses has a trigger unit, and when the trigger unit is triggered, the pair of shutter glasses sends the first information packet.

According to an embodiment of the present invention, the display apparatus has an on-screen display for indicating that the display apparatus finishes receiving the first information packet.

In view of the above, through the method for pairing the pair of shutter glasses and the display apparatus of the present invention, the limitation of pairing the pair of shutter glasses with the display apparatus in the prior art may be solved, and further the wired communication interface between the two devices may effectively reduce manufacturing cost.

### BRIEF DESCRIPTION OF THE DRAWINGS

The present invention will become more fully understood from the detailed description given herein below for illustration only, and thus are not limitative of the present invention, and wherein:

FIG. 1A is a schematic diagram showing the system of a pair of shutter glasses when being used in viewing a 3D image according to a first embodiment of the present invention;

FIG. 1B is a circuit block diagram of the pair of shutter glasses in FIG. 1A;

FIG. 1C is a flow chart of a pairing method for the pair of shutter glasses according to the first embodiment of the present invention;

FIG. 2A to FIG. 2C are schematic diagrams showing the system of a pair of shutter glasses when being used in viewing a 3D image according to a second embodiment of the present invention;

FIG. 2D is a circuit block diagram of the pair of shutter glasses in FIG. 2A to FIG. 2C;

FIG. 2E is a flow chart of a pairing method according to the second embodiment of the present invention;

FIG. 3A is a circuit block diagram of a display apparatus and a pair of shutter glasses which are paired for viewing a 3D image according to a third embodiment of the present invention;

FIG. 3B to FIG. 3C are schematic diagrams showing the system of FIG. 3A;

FIG. 3D is a flow chart of a pairing method for the display apparatus according to the third embodiment of the present invention;

FIG. 4A is a schematic diagram illustrating the setting of the display apparatus before receiving an information packet according to the third embodiment of the present invention; and

FIG. 4B is a schematic diagram illustrating the setting of the display apparatus after receiving the information packet according to the third embodiment of the present invention.

### DETAILED DESCRIPTION OF THE INVENTION

The detailed features and advantages of the present invention are described below in great detail through the following embodiments, and the content of the detailed description is sufficient for persons skilled in the art to understand the technical content of the present invention and to implement the present invention there accordingly. Based upon the content of the specification, the claims, and the drawings, persons skilled in the art can easily understand the relevant objectives and advantages of the present invention.

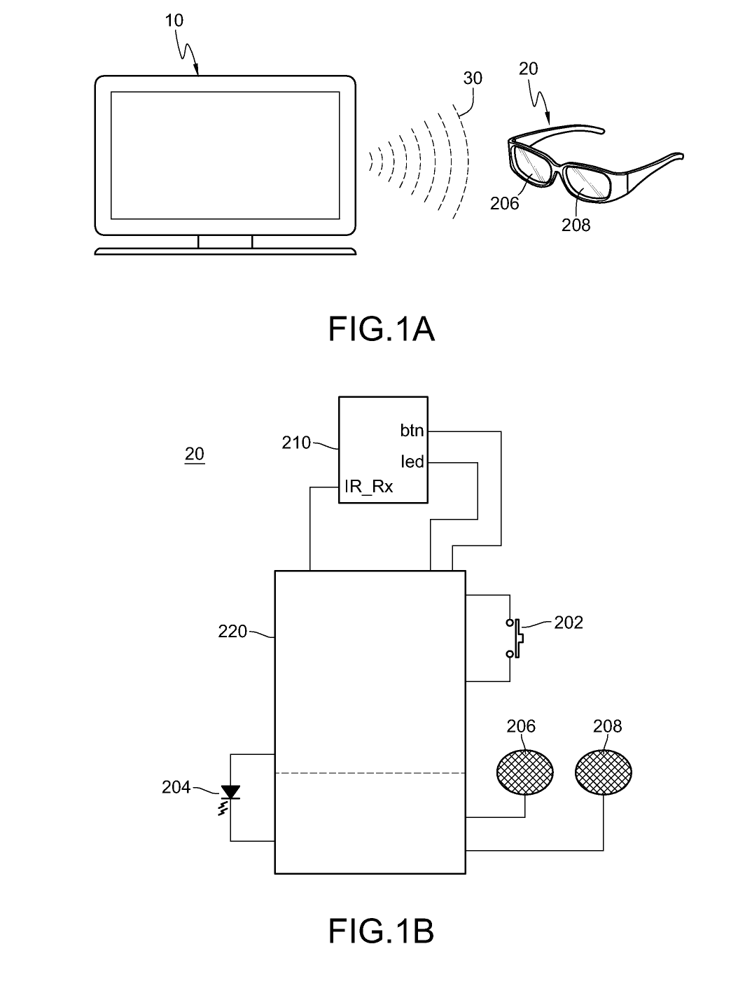

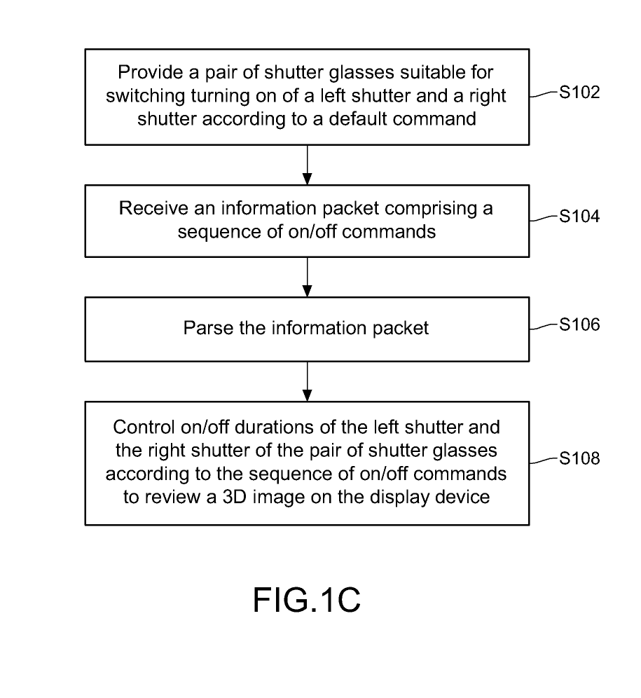

FIG. 1A is a schematic diagram showing the system of a pair of shutter glasses when being used in viewing a 3D image according to a first embodiment of the present invention. FIG. 1B is a circuit block diagram of the pair of shutter glasses in FIG. 1A. The pair of shutter glasses 20 is operable to review a 3D image displayed on a display apparatus 10, and the display apparatus 10 may be, but not limited to, a 3D Liquid Crystal Display (LCD). Hereinafter, the pairing use of the pair of shutter glasses 20 and the display apparatus 10 is described as follows with reference to a flow chart of FIG. 1C.

The pair of shutter glasses 20 comprises a trigger unit 202, an indication unit 204, a left shutter 206, a right shutter 208, a first microprocessor 210 and a second microprocessor 220, which are electrically interconnected. The first microprocessor 210 and the second microprocessor 220 may be, but not limited to, two independent circuit blocks, and the first microprocessor 210 and the second microprocessor 220 may be optionally integrated on a silicon-on-chip (SOC). The trigger unit 202 may be, but not limited to, a physical button disposed on a casing of the pair of shutter glasses 20 or a virtual button with a touch control function. The indication unit 204 may be, but not limited to, a light emitting diode (LED), a loudspeaker, or a buzzer for sending an indication signal (for example, projecting a light or sounding) to indicate a status of the pair of shutter glasses 20. Hereinafter, the indication unit 204 is referred as the LED capable of projecting a light to indicate a status of the pair of shutter glasses 20 for illustration of the embodiment of the present invention; however, in other embodiments, the indication unit 204 may also be a loudspeaker or a buzzer.

In specific, referring to FIG. 1A to FIG. 1C, in a method for pairing the pair of shutter glasses 20 and the display apparatus 10 according to the first embodiment of the present invention, the pair of shutter glasses 20 is suitable for switching turning on of the left shutter 206 and the right shutter 208 according to a default command, and the default command may vary in accordance with the brand of the pair of shutter glasses 20 (Step S102). At first, a user may directly turn on a wireless emitting function of the display apparatus 10, for example, an infrared ray synchronous emission, a microwave emission, or a wireless radio frequency emission function or the like. Here, the display apparatus 10 may send an information packet 30 having a specific code through infrared rays, microwaves, or radio frequency electromagnetic waves, in which the information packet 30 comprises a sequence of on/off commands and the sequence of on/off commands are different from the default command of the pair of shutter glasses 20. Therefore, according to the first embodiment of the present invention, after the trigger unit 202 is triggered (for example, the user presses the button on the pair of shutter glasses 20), the pair of shutter glasses 20 receives the information packet 30 sent from the display apparatus 10 (Step S104).

Generally speaking, the pair of shutter glasses 20 may finish receiving the information packet 30 within 1/60 seconds since the trigger unit 202 is triggered. After receiving the information packet 30, the pair of shutter glasses 20 may perform a parsing (or decoding) action on the information packet 30 through an internal processor unit (comprising a firmware program of the first microprocessor 210) (Step S106). Then, the indication unit 204 emits a light to indicate that the pair of shutter glasses 20 finishes decoding the information packet 30. Therefore, the second microprocessor 220 may control on/off durations respectively corresponding to each of the left shutter 206 and the right shutter 208 of the pair of shutter glasses 20 according to the sequence of on/off commands in the information packet 30, and further continuously switch the left shutter 206 and the right shutter 208. In this situation, the user can view the 3D image presented by the display apparatus 10 by wearing the pair of shutter glasses 20 (Step S108).

The manner of transferring the information packet 30 from the display apparatus 10 to the pair of shutter glasses 20 is not limited to the wireless manner. In other words, the information packet 30 may also be transferred from the display apparatus 10 to the pair of shutter glasses 20 in a wired manner. When being transferred in the wired manner, the information packet 30 is transferred to the pair of shutter glasses 20 via a universal serial bus (USB) interface on the display apparatus 10.

Therefore, in the method for pairing the pair of shutter glasses and the display apparatus according to the first embodiment of the present invention, under the circumstance without replacing the display apparatus, the user may use the same pair of shutter glasses to receive and parse the information packets sent from television sets of different brands and then view the 3D images displayed by the display apparatuses of different brands.

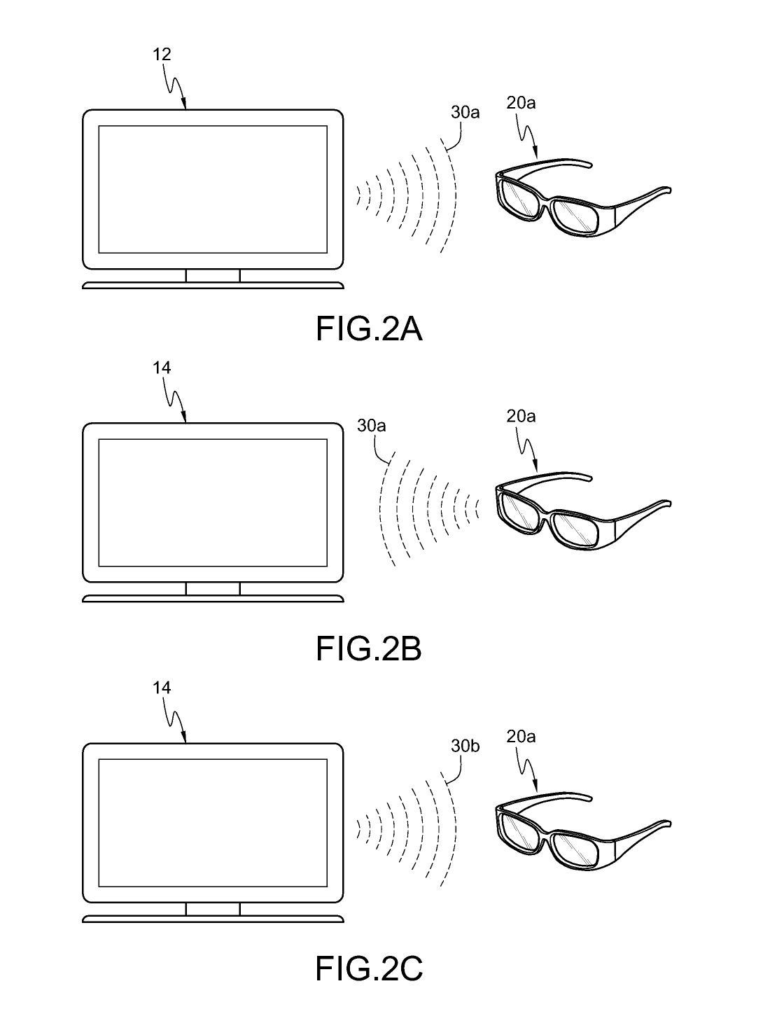

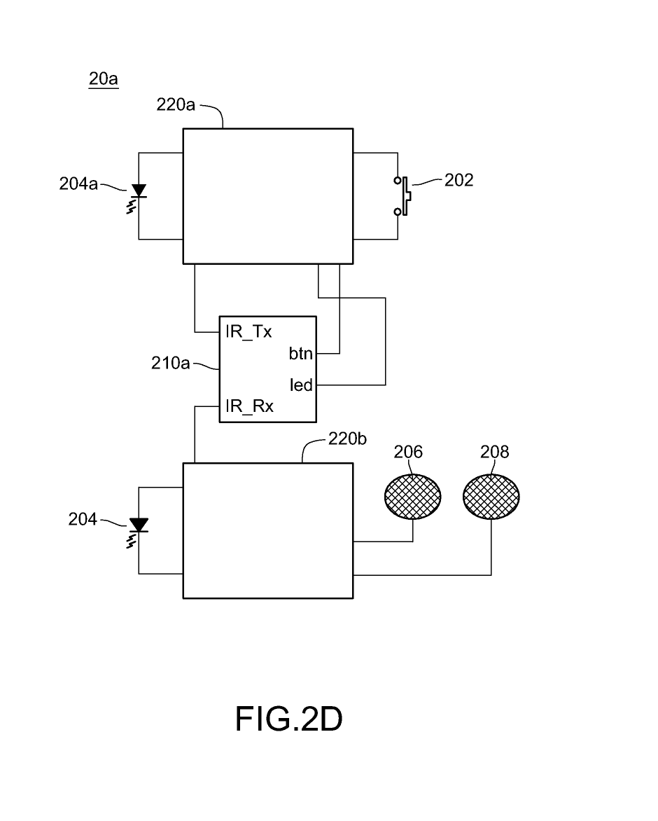

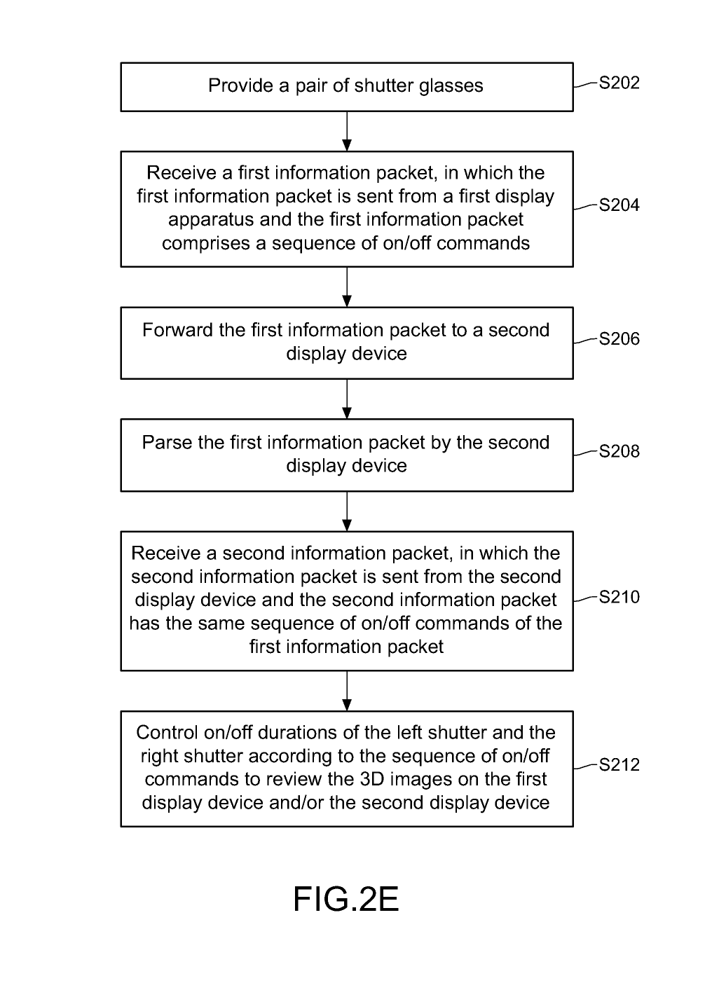

FIG. 2A to FIG. 2C are schematic diagram showing the system of a pair of shutter glasses when being used in viewing a 3D image according to a second embodiment of the present invention. FIG. 2D is a circuit block diagram of the pair of shutter glasses in FIG. 2A to FIG. 2C. A first display apparatus 12 and a second display apparatus 14 are 3D LCDs of different brands. Hereinafter, the pairing of the first display apparatus 12 and the second display apparatus 14 respectively with the pair of shutter glasses 20a for viewing the 3D image is illustrated with reference to a flow chart of FIG. 2E.

The pair of shutter glasses 20a comprises a trigger unit 202, indication units 204, 204a, a left shutter 206, a right shutter 208, a first microprocessor 210a, and second microprocessors 220a, 220b, which are all electrically interconnected. The trigger unit 202 may be, but not limited to, a physical button disposed on a casing of the pair of shutter glasses 20a or a virtual button with a touch control function. The indication units 204, 204a may be, but not limited to, LEDs for sending an indication signal to indicate a status of the pair of shutter glasses 20a. The first microprocessor 210a and the second microprocessors 220a, 220b may be optionally integrated on an SOC.

In specific, referring to FIG. 2A to FIG. 2E, in a pairing method for the pair of shutter glasses according to the second embodiment of the present invention, a user firstly provides the pair of shutter glasses 20a (Step S202), and turns on a wireless emitting function of the first display apparatus 12, for example, an infrared ray synchronous emission, a microwave emission, a wireless radio frequency emission function or the like. Here, the first display apparatus 12 may send a first information packet 30a having a specific code through infrared rays, microwaves, or radio frequency electromagnetic waves, in which the first information packet 30a comprises a sequence of on/off commands. For example, after the trigger unit 202 is triggered to make the pair of shutter glasses 20a receive the signal (for example, the user presses and holds the button on the pair of shutter glasses 20a for 1/60 seconds), the pair of shutter glasses 20a receives the first information packet 30a sent from the first display apparatus 12 (Step S204) and temporally saves the data of the first information packet 30a in a built-in storage unit.

Then, when the trigger unit 202 is triggered again and for over a threshold period, the pair of shutter glasses 20a enters a stage of emitting the signal (for example, the user presses and holds the button on the pair of shutter glasses 20a for 3 seconds or more), and the pair of shutter glasses 20a may forward the first information packet 30a received from the first display apparatus 12 to the second display apparatus 14 by an emitting terminal IR_Tx of the first microprocessor 210a (Step S206). Here, the user may firstly switch the second display apparatus 14 from a television remote control status to a 3D glasses communication status on an on-screen display of the second display apparatus 14 to allow the second display apparatus 14 to receive the first information packet 30a. After the second display apparatus 14 finishes receiving the first information packet 30a, for example, the second display apparatus 14 sends back a confirmation signal to the pair of shutter glasses 20a. When the forwarding step is finished, the indication unit 204a of the pair of shutter glasses 20a may emit a light to indicate that the pair of shutter glasses 20a has successfully finished forwarding the first information packet 30a to the second display apparatus 14.

It should be noted that after the second display apparatus 14 finishes receiving the first information packet 30a, an internal driving program of the second display apparatus 14 (comprising a software program or a hardware circuit) may automatically analyze, parse or compare the signal of the first information packet 30a with an index value to identify the meaning of the signal of the first information packet 30a (Step S208). When finishing the above parsing or comparing procedure and confirming the meaning of the signal of the first information packet 30a, the second display apparatus 14 may send the second information packet 30b having the same sequence of on/off commands of the first information packet 30a through the wireless transmission function (for example, the infrared ray transmission or the wireless radio transmission function). The user may presses the trigger unit 202 on the pair of shutter glasses 20a again to receive the second information packet 30b sent from the second display apparatus 14 (Step S210).

Thereafter, the second microprocessor 220b may control on/off durations respectively corresponding to each of the left shutter 206 and the right shutter 208 of the pair of shutter glasses 20a according to the sequence of on/off commands in the second information packet 30b to continuously switch the left shutter 206 and the right shutter 208. In this situation, the user may view the 3D image presented by the second display apparatus 14 when wearing the pair of shutter glasses 20a (Step S212).

Besides, as the contents of the information in the second information packet 30b and the first information packet 30a are the same, even if the user only has the pair of shutter glasses paired with the first display apparatus 12, the pair of shutter glasses may also be used to view the 3D image presented by the second display apparatus 14. Therefore, according to the pairing method of the second embodiment of the present invention, the pair of shutter glasses originally paired with the first display apparatus 12 may have the function for viewing the second display apparatus 14, thereby effectively solving the problem that a pair of shutter glasses is limited to be applied to display apparatuses of a brand.

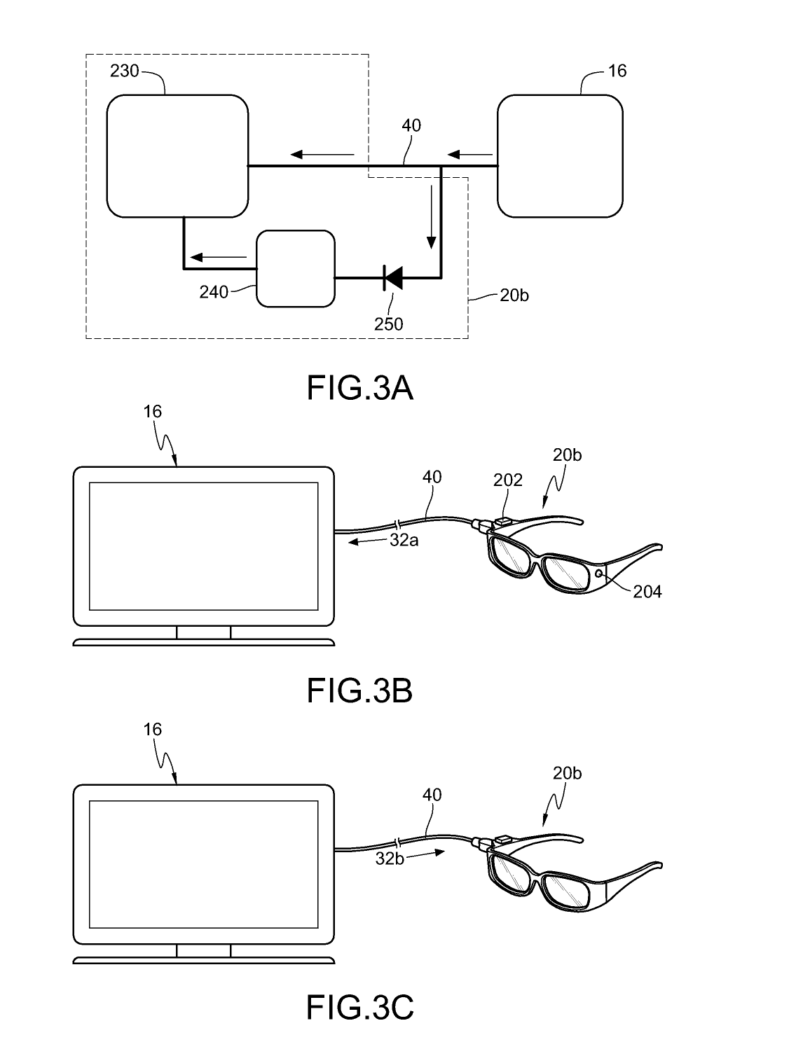

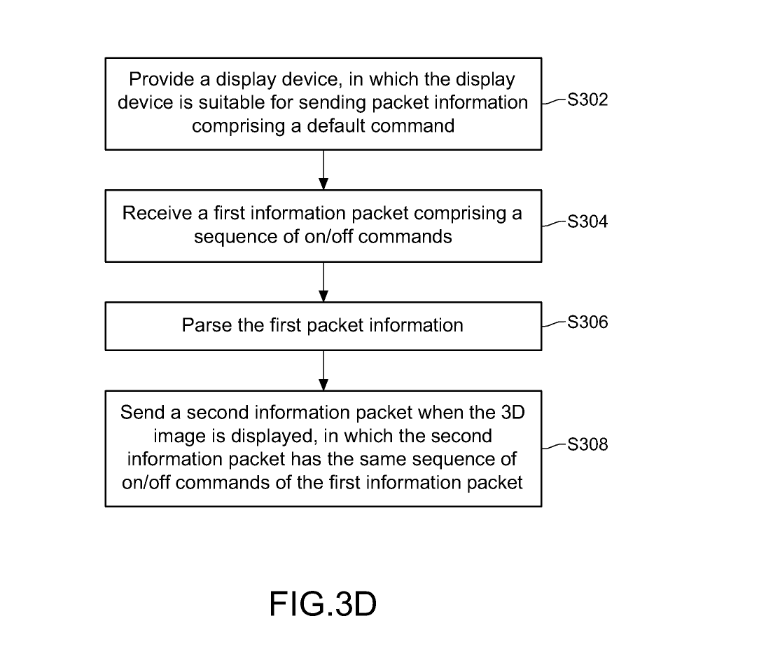

FIG. 3A is a circuit block diagram of a display apparatus and a pair of shutter glasses which are paired for viewing a 3D image according to a third embodiment of the present invention. FIG. 3B to FIG. 3C are schematic diagrams showing the system of FIG. 3A. The pair of shutter glasses 20b is operable to review the 3D image displayed by the display apparatus 16, and the display apparatus 16 may be, but not limited to, a 3D LCD. Hereinafter, the pairing use of the pair of shutter glasses 20b with the display apparatus 16 for viewing the 3D image is illustrated with reference to a flow chart of FIG. 3D.

The pair of shutter glasses 20b comprises a microprocessor 230, a power module 240, and a freewheeling diode 250, and the pair of shutter glasses 20b is electrically connected to the display apparatus 16 via a universal serial bus interface 40. Here, the display apparatus 16 supplies power for operation of the pair of shutter glasses 20b via the universal serial bus interface 40, and communication between the display apparatus 16 and the pair of shutter glasses 20b is also achieved by the universal serial bus interface 40 (detailed description is illustrated hereafter).

As shown in FIG. 3B, a user firstly provides the display apparatus 16. Generally speaking, when normally displaying the 3D image, the display apparatus 16 sends a default command in packet information to control on/off actions of a left shutter and a right shutter of the pair of shutter glasses paired with it (Step S302). Thereafter, the user makes the pair of shutter glasses 20b send a first information packet 32a by triggering a trigger unit 202 on the pair of shutter glasses 20b, in which the first information packet 32a comprises a sequence of on/off commands. An indication unit 204 on the pair of shutter glasses 20b starts emitting the light to indicate that the display apparatus 16 is receiving the first information packet 32a. When the indication unit 204 stops emitting the light, the user may know that the display apparatus 16 has received the first information packet 32a successfully (Step S304).

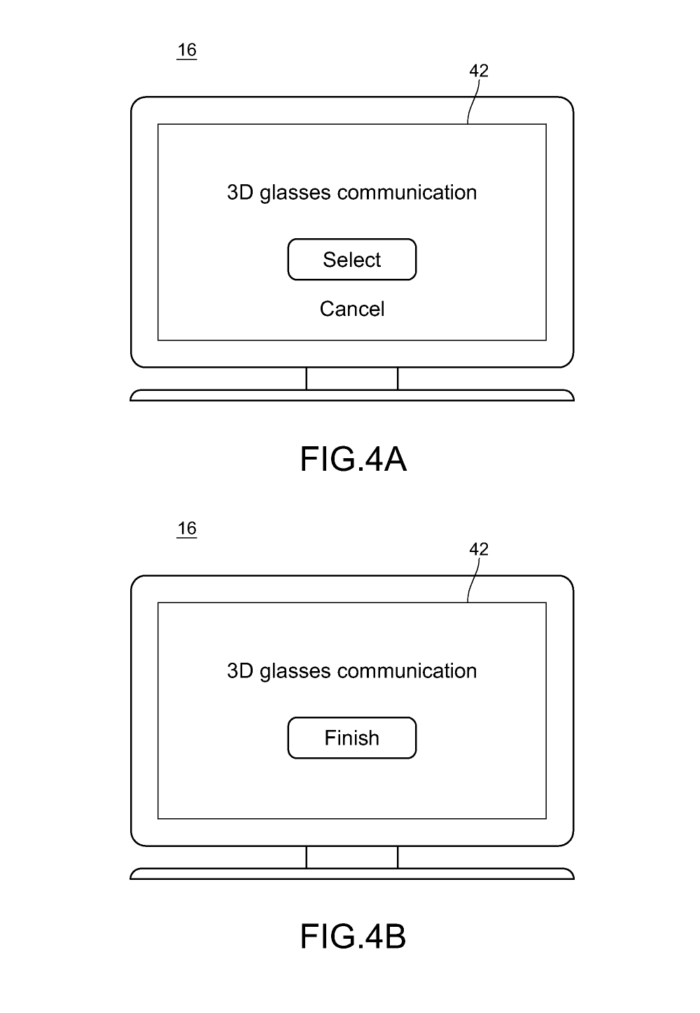

Then, referring to FIG. 4A and FIG. 4B, the user may also switch the display apparatus 16 from a television remote control status to a 3D glasses communication status by way of setting an on-screen display 42 on the display apparatus 16, so that the display apparatus 16 can successfully receive the first information packet 32a via the universal serial bus interface 40. After Step S304 is finished, the on-screen display 42 may indicate that the display apparatus 16 finishes receiving the first information packet 32a on the screen.

In this situation, as described in the preceding embodiment, the display apparatus 16 parses the signal of the first information packet 32a through the internal driving program (comprising the software program or the hardware circuit) or compares the signal of the first information packet 32a with the index value to identify the meaning of the signal of the first information packet 32a (Step S306). After finishing the parsing (comparison) procedure, it is confirmed whether “the on/off commands in the first information packet 32a” are the same as “the default command sent from the display apparatus 16 for controlling the actions of its pair of shutter glasses when normally displaying a 3D image “. If those are different, the display apparatus 16 automatically takes the on/off commands in the first information packet 32a as the commands for controlling turning on/off of the pair of shutter glasses when the 3D image is displayed. Here, as shown in FIG. 3C, the display apparatus 16 may send the second information packet 32b having the same sequence of on/off commands of the first information packet 32a via the universal serial bus interface 40 again (Step S308).

Therefore, when the second information packet 32b is transferred from the display apparatus 16 to the pair of shutter glasses 20b, the pair of shutter glasses 20b may control on/off durations respectively corresponding to each of its left shutter and right shutter according to the sequence of on/off commands to review the 3D image presented by the display apparatus 16.

A particular explanation lies in this embodiment, that although the display apparatus 16 confirms whether “the on/off commands comprised in the first information packet 32a” are the same as “the default command sent from the display apparatus 16 for controlling the actions of its pair of shutter glasses when normally displaying a 3D image ”, when those commands are different, the display apparatus 16 automatically takes the on/off commands in the first information packet 32a as the commands for controlling turning on/off of the pair of shutter glasses when the 3D image is displayed, which is not intended to limit the scope of the present invention. In other words, in other embodiments of the present invention, for example, the display apparatus 16 may also skip the step of confirming whether those commands are the same, and directly takes the on/off commands in the first information packet 32a as the commands for controlling turning on/off of the pair of shutter glasses when the 3D image is displayed.

In summary, in the display apparatus and the pairing method according to the third embodiment of the present invention, under the circumstance without replacing the pair of shutter glasses, the user may use the display apparatus to receive and send the information packet suitable for controlling the pair of shutter glasses. Therefore, the user can view the 3D image displayed by the display apparatus when wearing the pair of shutter glasses of any brand.

Besides, according to the third embodiment of the present invention, the display apparatus and the pair of shutter glasses achieve the communication protocol of the power and the communication signal at the same time via the universal serial bus interface. Therefore, the stability of the communication between the two devices is improved and also the cost is effectively reduced by the wired communication.

Furthermore, although the signal transfer between the display apparatus and the pair of shutter glasses is realized in a manner of information packet, it may also be done in a manner of directly transferring unpacketized data.

What is claimed is:

1. A pairing method, comprising:
providing a pair of shutter glasses suitable for switching turning on of a left shutter and a right shutter according to a default command;
receiving an information packet comprising a sequence of on/off commands from a display apparatus;
parsing the information packet; and
controlling on/off durations of the left shutter and the right shutter of the pair of shutter glasses according to the sequence of on/off commands to review a three-dimensional (3D) image on the display apparatus, wherein the sequence of on/off commands are different from the default command.

2. The pairing method according to claim 1, wherein the information packet is transferred from the display apparatus to the pair of shutter glasses in a wired or wireless manner.

3. The pairing method according to claim 2, wherein when being transferred in the wireless manner, the information packet is transferred to the pair of shutter glasses through infrared rays, microwaves, or radio frequency electromagnetic waves, and when being transferred in the wired manner, the information packet is transferred to the pair of shutter glasses via a universal serial bus interface.

4. The pairing method according to claim 1, wherein the pair of shutter glasses has a trigger unit, and when the trigger unit is triggered, the pair of shutter glasses receives the information packet.

5. The pairing method according to claim 1, wherein the pair of shutter glasses has an indication unit, and the indication unit sends an indication signal to indicate a status of the pair of shutter glasses.

6. A pairing method, comprising:
providing a pair of shutter glasses;
receiving a first information packet, wherein the first information packet is sent from a first display apparatus and the first information packet comprises a sequence of on/off commands;
forwarding the first information packet to a second display apparatus by the pair of shutter glasses;
parsing the first information packet by the second display apparatus;
receiving a second information packet, wherein the second information packet is sent from the second display apparatus and the second information packet has the same sequence of on/off commands of the first information packet; and
controlling on/off durations of the left shutter and the right shutter of the pair of shutter glasses according to the sequence of on/off commands to review three-dimensional (3D) images on the first display apparatus and/or the second display apparatus.

7. The pairing method according to claim 6, wherein the pair of shutter glasses has a trigger unit, and when the trigger unit is triggered, the pair of shutter glasses receives the first information packet.

8. The pairing method according to claim 7, wherein the pair of shutter glasses has an emitting terminal, and when the trigger unit is triggered for over a threshold period, the emitting terminal of the pair of shutter glasses forwards the first information packet to the second display apparatus.

9. The pairing method according to claim 6, wherein the pair of shutter glasses has an indication unit, and when the pair of shutter glasses finishes forwarding the first information packet, the indication unit sends an indication signal.

10. A pairing method, comprising:
providing a display apparatus suitable for sending packet information comprising a default command;
receiving a first information packet, wherein the first information packet is sent from a pair of shutter glasses and the first information packet comprises a sequence of on/off commands;
parsing the first information packet; and
sending a second information packet when a three-dimensional (3D) image is displayed, wherein the second information packet has the same sequence of on/off commands of the first information packet and the sequence of on/off commands are different from the default command.

11. The pairing method according to claim 10, wherein the first information packet is transferred from the pair of shutter glasses to the display apparatus via a universal serial bus interface.

12. The pairing method according to claim 10, wherein the pair of shutter glasses has a trigger unit, and when the trigger unit is triggered, the pair of shutter glasses sends the first information packet.

13. The pairing method according to claim 10, wherein the display apparatus has an on-screen display for indicating that the display apparatus finishes receiving the first information packet.

14. A pairing method, comprising:
providing a pair of shutter glasses suitable for switching turning on of a left shutter and a right shutter according to a default command;
receiving a sequence of on/off commands sent from a display apparatus;
parsing the sequence of on/off commands; and
controlling on/off durations of the left shutter and the right shutter of the pair of shutter glasses according to the sequence of on/off commands to review a three-dimensional (3D) image on the display apparatus, wherein the sequence of on/off commands are different from the default command.

15. A pairing method, comprising:
providing a pair of shutter glasses;
receiving a first sequence of on/off commands, wherein the first sequence of on/off commands are sent from a first display apparatus;
forwarding the first sequence of on/off commands to a second display apparatus by the pair of shutter glasses;
parsing the first sequence of on/off commands by the second display apparatus;
receiving a second sequence of on/off commands, wherein the second sequence of on/off commands are sent from the second display apparatus and the second sequence of on/off commands are the same as the first sequence of on/off commands; and
controlling on/off durations of the left shutter and the right shutter of the pair of shutter glasses according to the second sequence of on/off commands to review three-dimensional (3D) images on the first display apparatus and/or the second display apparatus.

16. A pairing method, comprising:
providing a display apparatus suitable for sending packet information comprising a default command;
receiving a first sequence of on/off commands, wherein the first sequence of on/off commands are sent from a pair of shutter glasses;
parsing the first sequence of on/off commands; and
sending a second sequence of on/off commands when a three-dimensional (3D) image is displayed, wherein the second sequence of on/off commands are the same as the first sequence of on/off commands and the second sequence of on/off commands are different from the default command.
